(19) United States
(12) Patent Application Publication
(10) Pub. No.: US 2026/0236248 A1
(43) Pub. Date: Aug. 13, 2026

(54) SYSTEM UPGRADING METHOD AND APPARATUS, AND DEVICE AND STORAGE MEDIUM

(71) Applicant: CHINA UNIONPAY CO., LTD., Shanghai (CN)

(72) Inventor: Tie LIU, Shanghai (CN)

(21) Appl. No.: 19/153,427

(22) PCT Filed: Oct. 24, 2023
(86) PCT No.: PCT/CN2023/126193

§ 371 Date: Aug. 4, 2025

(30) Foreign Application Priority Data
Feb. 10, 2023 (CN) 202310101484.8

(51) Int. Cl. G06F 8/65; G06F 8/41

(52) U.S. Cl. CPC G06F 8/65; G06F 8/427

(57) ABSTRACT

A system upgrade method includes: parsing a source code file of a system to be upgraded to obtain a preliminary directed acyclic graph; supplementing program feature information corresponding to respective nodes according to functional metrics corresponding to the respective nodes in the preliminary directed acyclic graph to obtain a target directed acyclic graph; splitting the target directed acyclic graph into a plurality of directed acyclic subgraphs based on a plurality of root nodes in the target directed acyclic graph, so as to obtain a plurality of transformation recommendation paths and generate a final upgrade decision plan based on the plurality of transformation recommendation paths.

### CROSS-REFERENCE TO RELATED APPLICATIONS

The present application is a national phase entry under 35 U.S.C § 371 of International Patent Application No. PCT/CN2023/126193, filed on Oct. 24, 2023, which claims priority to Chinese patent application No. 202310101484.8, filed on Feb. 10, 2023, the entire contents of all of which are incorporated herein by reference for all purposes.

### TECHNICAL FIELD

The embodiments of the present application relate to the technical field of computers, particularly to a system upgrade method, apparatus, device and storage medium.

### BACKGROUND TECHNOLOGY

Software project development often faces the need to modernization transformation research and development of legacy systems. The legacy systems commonly suffer from outdated architectures, complex module relationships, and multi-language combination development, among other issues, which pose significant technical obstacles to the modernization transformation research and development of the legacy systems.

In related technologies, third-party auxiliary tools are used to collect various metrics of the legacy systems, such as static code scanning or third-party component scanning tools. Based on scan reports provided by these tools, the legacy systems are manually analyzed and modified. Alternatively, new systems are re-designed based on the functional requirements of legacy systems. However, the aforementioned technical solutions require significant resource investment and are associated with low development efficiency and high risks.

The embodiments of the present application provide a system upgrade method, apparatus, device and storage medium, intended to improve efficiency of modernization transformation research and development of legacy system, while lowering resource investment and reducing transformation risks.

In one aspect, the embodiments of the present application provide a system upgrade method, comprising: acquiring a source code file of a system to be upgraded; parsing the source code file to obtain a corresponding preliminary directed acyclic graph, the preliminary directed acyclic graph representing code structure description data of the source code file; supplementing program feature information corresponding to each of nodes according to functional metrics corresponding to each of the nodes in the preliminary directed acyclic graph to obtain a target directed acyclic graph; splitting the target directed acyclic graph into a plurality of directed acyclic subgraphs based on a plurality of root nodes in the target directed acyclic graph, each of the directed acyclic subgraphs corresponding to an upgrade implementation path; and determining an upgrade decision plan for the system to be upgraded based on the plurality of directed acyclic subgraphs.

In one aspect, the embodiments of the present application provide a computer device. The computer device includes one or more processors; and a memory containing a computer program that, when being executed, causes the one or more processors to perform: acquiring a source code file of a system to be upgraded; parsing the source code file to obtain a corresponding preliminary directed acyclic graph, the preliminary directed acyclic graph representing code structure description data of the source code file; supplementing program feature information corresponding to each of nodes according to functional metrics corresponding to each of the nodes in the preliminary directed acyclic graph to obtain a target directed acyclic graph; splitting the target directed acyclic graph into a plurality of directed acyclic subgraphs based on a plurality of root nodes in the target directed acyclic graph, each of the directed acyclic subgraphs corresponding to an upgrade implementation path; and determining an upgrade decision plan for the system to be upgraded based on the plurality of directed acyclic subgraphs.

In one aspect, the embodiments of the present application provide a non-transitory computer-readable storage medium containing a computer program that, when being executed, causes at least one processor to perform: acquiring a source code file of a system to be upgraded; parsing the source code file to obtain a corresponding preliminary directed acyclic graph, the preliminary directed acyclic graph representing code structure description data of the source code file; supplementing program feature information corresponding to each of nodes according to functional metrics corresponding to each of the nodes in the preliminary directed acyclic graph to obtain a target directed acyclic graph; splitting the target directed acyclic graph into a plurality of directed acyclic subgraphs based on a plurality of root nodes in the target directed acyclic graph, each of the directed acyclic subgraphs corresponding to an upgrade implementation path; and determining an upgrade decision plan for the system to be upgraded based on the plurality of directed acyclic subgraphs.

In the embodiments of the present application, a source code file of a system to be upgraded is parsed to obtain a corresponding directed acyclic graph; subsequently, program feature information corresponding to each of nodes in the directed acyclic graph is supplemented; further, the directed acyclic graph is split into a plurality of directed acyclic subgraphs to obtain a plurality of transformation recommendation paths; still further, a final upgrade decision plan is generated based on the plurality of transformation recommendation paths. As such, problems of a legacy system are effectively identified, and solutions that align the program with optimal design principles such as single responsibility principle, functional isolation, clear hierarchy, high cohesion and low coupling, are also provided, thereby significantly reducing manual analysis and design costs, improving efficiency of modernization transformation research and development of the legacy system, avoiding transformation errors, and reducing transformation risks.

### BRIEF DESCRIPTION OF DRAWINGS

To illustrate the technical solutions in the embodiments of the present application more clearly, the accompanying drawings required for describing the embodiments are briefly introduced below. As is evident, the accompanying drawings in the following description are merely some embodiments of the present application. For those skilled in the art, other drawings may be derived from the accompanying drawings without investing creative work.

FIG. 1 is a schematic structural diagram of a system architecture according to an embodiment of the present application;

FIG. 2 is a schematic flowchart of a system upgrade method according to an embodiment of the present application;

FIG. 3 is a schematic diagram of an original graph structure according to an embodiment of the present application;

FIG. 4 is a schematic diagram of an intermediate graph structure according to an embodiment of the present application;

FIG. 5 is a schematic diagram of a preliminary directed acyclic graph according to an embodiment of the present application;

FIG. 6 is a schematic diagram of functional metrics according to an embodiment of the present application;

FIG. 7 is a schematic flowchart of a system upgrade method according to an embodiment of the present application;

FIG. 8 is a schematic flowchart of a system upgrade method according to an embodiment of the present application;

FIG. 9 is a schematic structural diagram of a system upgrade apparatus according to an embodiment of the present application;

FIG. 10 is a schematic structural diagram of a computer device according to an embodiment of the present application.

### DETAILED DESCRIPTION OF EMBODIMENTS

To make the objectives, technical solutions, and beneficial effects of the present application clearer, the present application is further described in detail below, with reference to the accompanying drawings and embodiments. As should be understood, the specific embodiments described herein are merely used to explain the present application, rather than intended to limit the present application.

For ease of understanding, terms involved in the embodiments of the present application are explained below.

Legacy System (LS): A computer system that is relatively outdated in terms of architecture and other aspects.

Modernization Transformation Research and Development (MTRD): The process of transforming existing systems using cutting-edge technology.

Embodiments of the present application provide a system upgrade method, apparatus, device and storage medium, relating to the technical field of computers. The method comprises: parsing a source code file of a system to be upgraded to obtain a preliminary directed acyclic graph; supplementing program feature information corresponding to respective nodes according to functional metrics corresponding to the respective nodes in the preliminary directed acyclic graph to obtain a target directed acyclic graph; splitting the target directed acyclic graph into a plurality of directed acyclic subgraphs based on a plurality of root nodes in the target directed acyclic graph, so as to obtain a plurality of transformation recommendation paths and, further, generating a final upgrade decision plan based on the plurality of transformation recommendation paths. As such, problems of a legacy system are effectively identified, and solutions that align the program with optimal design principles such as single responsibility principle, functional isolation, clear hierarchy, high cohesion and low coupling, are also provided, thereby significantly reducing manual analysis and design costs, improving efficiency of modernization transformation research and development of the legacy system, avoiding transformation errors, and reducing transformation risks.

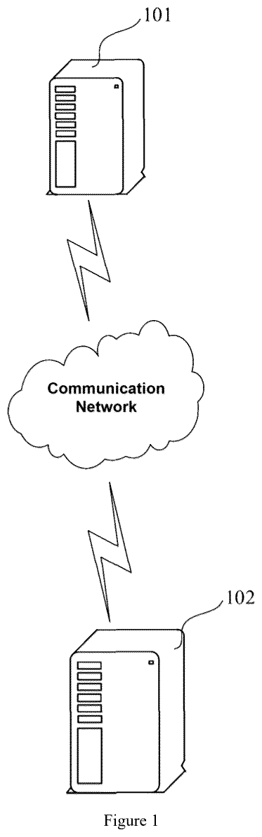

Referring to FIG. 1, FIG. 1 illustrates a system architecture applicable to the embodiments of the present application, wherein the system architecture at least comprises a legacy system 101 and a modernization transformation research and development apparatus of legacy system 102. The number of legacy system 101 may be one or more, and the present application does not specifically limit the number of legacy system 101.

The modernization transformation research and development apparatus of legacy system 102 may be an independent physical server, a server cluster or distributed system composed of multiple physical servers, or a cloud server providing fundamental cloud computing services such as cloud services, cloud databases, cloud computing, cloud functions, cloud storage, network services, cloud communication, middleware services, domain name services, security services, content delivery network (CDN), and big data and artificial intelligence platforms. The legacy system 101 and the modernization transformation research and development apparatus of legacy system 102 may be directly or indirectly connected via wired or wireless communication, without any limitation imposed by the present application. A system upgrade method according to the present application involves modernization transformation research and development of legacy system, and may also be applied to system development scenarios such as cloud migration.

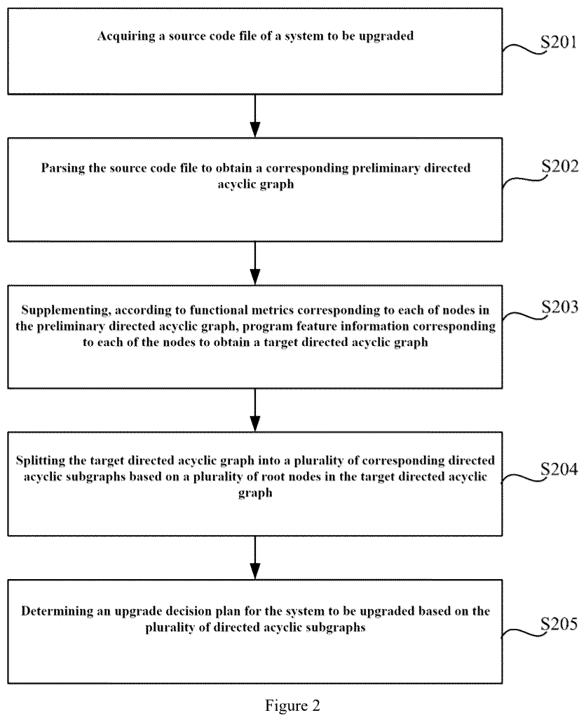

Based on the system architecture shown in FIG. 1, the embodiments of the present application provide a flow of a system upgrade method, as illustrated in FIG. 2, which is executed by a computer device, wherein the computer device may be the modernization transformation research and development apparatus of legacy system 102 shown in FIG. 1, and the system upgrade method comprises the following steps:
Step S201: Acquiring a source code file of a system to be upgraded.

Specifically, the system to be upgraded is a legacy system. The source code files of a plurality of modules of the legacy system are input into the modernization transformation research and development apparatus of legacy system. The source code files are written in one or more programming languages, the programming languages including but not limited to Java, C and Go.
Step S202: Parsing the source code file to obtain a corresponding preliminary directed acyclic graph.

Specifically, the preliminary directed acyclic graph represents code structure description data of the source code file, wherein the code structure description data comprises:
File name: Name of the source code file.
Function list: List of public function names in a current code.
Call code list: List of methods called by the current code from other classes.
Access code list: List of codes accessing functions in the current code.
Database access: Data operations involved in the current code.
File operations: File operations involved in the current code.
Parameterized configuration file list: Whether the current code uses configurable parameters.

In some embodiments, program layered design is a widely recognized optimal practice in the industry. A primary characteristic that disrupts the layered design is the presence of a cycle in the call chain of the code. Unless this cycle is a single-node cycle introduced by the program's recursive calls, the appearance of other cycles will disrupt the program's hierarchical structure, making maintenance and upgrades of the program more challenging. Thus, during the modernization transformation research and development of legacy system, identifying cycles in the program and optimizing the code containing cycles into a clearly layered program are necessary operations.

In view of this, the present application parses the source code file to obtain a corresponding original graph structure. On the condition that a directed cycle substructure exists in the original graph structure, the directed cycle substructure is converted into a directed acyclic substructure to obtain the preliminary directed acyclic graph; on the condition that no directed cycle substructure exists in the original graph structure, the original graph structure is directly used as the preliminary directed acyclic graph.

Specifically, the original graph structure obtained from parsing the source code file is a raw program structure of the source code file. The preliminary directed acyclic graph is a program structure obtained after transforming the cycles in the original program structure. The process of parsing the source code file to obtain the program structure is not restricted by a programming language of the source code file. For different programming languages, the source code files are parsed based on syntax rules corresponding to the programming languages of the source code files, thereby obtaining the corresponding original graph structures.

For example, when the programming language of the source code file is Java, a corresponding original graph structure is obtained by parsing Java bytecode in the source code file. When the programming language of the source code file is C, an original graph structure is obtained through Include header statements in C. When the programming language of the source code file is Go, the source code file is parsed using Go's Import syntax to obtain an original graph structure.

In embodiments of the present application, for different programming languages, parsing the source code file based on syntax rules corresponding to the programming language of the source code file to obtain the corresponding original graph structure effectively addresses the challenges of transforming legacy systems implemented in multiple programming languages.

In some embodiments, the embodiments of the present application converts directed cycle substructures into directed acyclic substructures, at least through the following means: adding a plurality of virtual nodes to the original graph structure, and transferring a portion of functions of at least one node in the directed cycle substructure to the plurality of virtual nodes, so as to convert the directed cycle substructure into a preliminary directed acyclic substructure; and merging the plurality of virtual nodes with a nearest upstream node in the preliminary directed acyclic substructure to obtain the preliminary directed acyclic graph.

Specifically, if the plurality of directed cycle substructures are identified in the original graph structure, i.e., there are a plurality of cycles in a program chain, each of the directed cycle substructures is converted into the directed acyclic substructure.

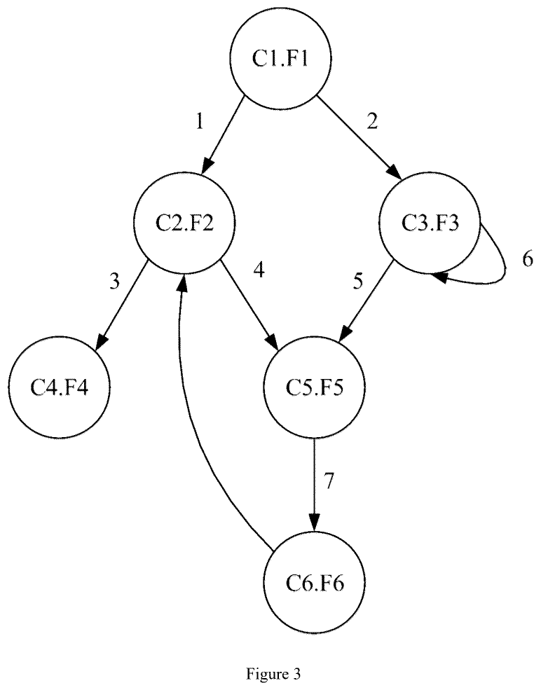

Taking the conversion process of a directed cycle substructure as an example, referring to FIG. 3, FIG. 3 is a schematic diagram of an original graph structure according to an embodiment of the present application, comprising nodes C1.F1, C2.F2, C3.F3, C4.F4, C5.F5, and C6.F6, wherein the nodes C2.F2, C5.F5, and C6.F6 form a directed cycle substructure.

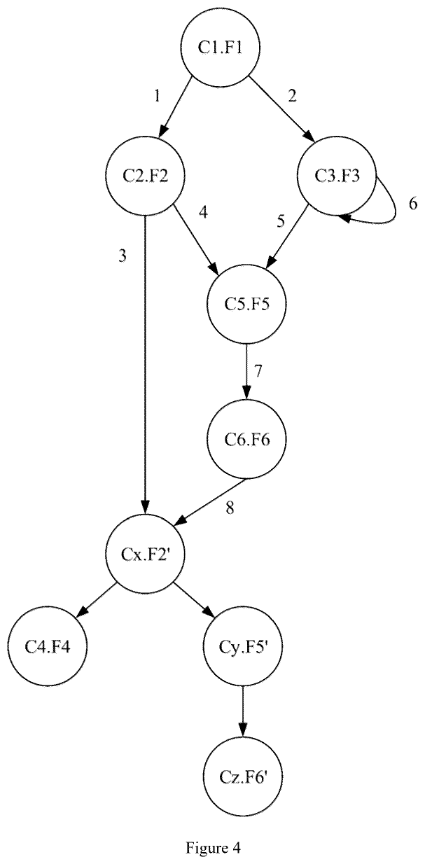

In the original graph structure shown in FIG. 3, virtual nodes Cx.F2′, Cy.F5′ and Cz.F6′ are added. A portion of functions of the node C2.F2 are transferred to the virtual node Cx.F2′ and, correspondingly, the call chains of the transferred functions to nodes C5.F5 and C6.F6 are transferred to virtual nodes Cy.F5′ and Cz.F6′, respectively, thereby obtaining the intermediate graph structure shown in FIG. 4. The intermediate graph structure comprises a preliminary directed acyclic substructure composed of the nodes C6.F6, C4.F4, as well as the virtual nodes Cx.F2′, Cy.F5′ and Cz.F6′.

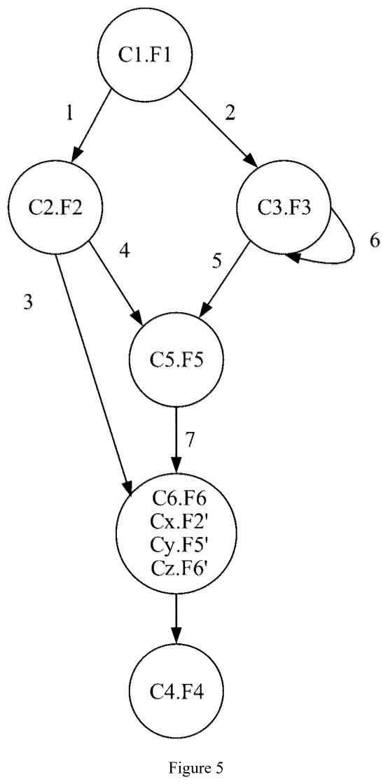

Further, in the preliminary directed acyclic substructure shown in FIG. 4, the nearest upstream node for the virtual nodes Cx.F2′, Cy.F5′ and Cz.F6′ is the node C6.F6. The virtual nodes Cx.F2′, Cy.F5′ and Cz.F6′ are merged with the node C6.F6, thereby obtaining the preliminary directed acyclic graph, i.e., a directed acyclic program structure, as specifically illustrated in FIG. 5.

In embodiments of the present application, during modernization transformation research and development of the legacy system, identifying directed cycles in a program and optimizing the directed cycles into directed acyclic structures clarifies the module relationships and various technical metrics of the legacy system across nodes at different levels of a tree, thereby obtaining a program with a clear hierarchy, thereby improving the efficiency of program maintenance and upgrade.
Step S203: Supplementing program feature information corresponding to each of nodes according to functional metrics corresponding to each of the nodes in the preliminary directed acyclic graph to obtain a target directed acyclic graph.

Specifically, the functional metrics comprise, but are not limited to: database access metrics, parameterization metrics, call chain throughput capacity metrics, call hierarchy metrics and external relationship metrics. Each of the nodes corresponds to one or more functional metrics.

In some embodiments, the program feature information of functional metrics corresponding to each node is obtained from the source code file through word segmentation technology. Subsequently, the program feature information corresponding to each node is supplemented according to the functional metrics corresponding to each of the nodes in the preliminary directed acyclic graph to obtain the target directed acyclic graph.

Specifically, through word segmentation processing, the program feature information associated with the specific functional metrics in source code is identified and supplemented to the corresponding nodes.

For example, for root nodes in the preliminary directed acyclic graph, Application Programming Interface (API) information and UI interface information are supplemented as node attributes. For intermediate nodes in a preliminary directed acyclic graph, information such as message middleware, network communication and file operations is supplemented as node attributes. For leaf nodes in a preliminary directed acyclic graph, usage information of current call hierarchy, synchronous/asynchronous, and multithreading/coroutine is supplemented as node attributes, thereby obtaining a target directed acyclic graph.

In embodiments of the present application, during modernization transformation research and development of legacy system, not only is the source code file parsed to obtain the preliminary directed acyclic graph, i.e., a program structure, but the program feature information corresponding to each of nodes is also simultaneously supplemented according to functional metrics corresponding to each of the nodes in the preliminary directed acyclic graph, thereby enriching the content of the obtained target directed acyclic graph and further facilitating the modernization transformation research and development of the legacy system.
Step S204: Splitting the target directed acyclic graph into a plurality of corresponding directed acyclic subgraphs based on a plurality of root nodes in the target directed acyclic graph.

Specifically, each of the directed acyclic subgraph corresponds to one upgrade implementation path (i.e., transformation recommendation path), and the upgrade implementation path may be represented by a topological sequence of the directed acyclic subgraph. The target directed acyclic graph is split into the plurality of corresponding directed acyclic subgraphs according to positions of plurality of root nodes in the target directed acyclic graph, wherein the root nodes correspond to the APIs, i.e., in API dimension. After obtaining the plurality of directed acyclic subgraphs, the program feature information of the functional metrics corresponding to each of the nodes is also rearranged.

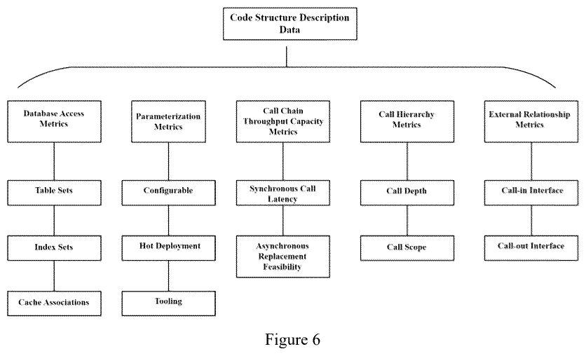

For example, as shown in FIG. 6, the functional metrics are set to include: database access metrics, parameterization metrics, call chain throughput capacity metrics, call hierarchy metrics and external relationship metrics. Expected indicators of the database access metrics under a transformation recommendation path comprise: table sets, index sets, and cache associations. Expected indicators of the parameterization metrics under a transformation recommendation path comprise: configurable, hot deployment, and tooling. Expected indicators of the call chain throughput capacity metrics under a transformation recommendation path comprise: synchronous call latency and asynchronous replacement feasibility. Expected indicators of the call hierarchy metrics under a transformation recommendation path comprise: call depth and call scope. And, expected indicators of the external relationship metrics under a transformation recommendation path comprise: call-in interfaces and call-out interfaces.

The directed acyclic program structure is split into the plurality of directed subgraphs by the API dimension, with the topological sequences of the directed subgraphs generated as the transformation recommendation path. Meanwhile, key features of each of the functional metrics are identified and correlated to provide optimal solutions and decision recommendations for modernization transformation and research of the legacy system, offering program transformation or migration paths.
Step S205: Determining an upgrade decision plan for the system to be upgraded based on the plurality of directed acyclic subgraphs.

In embodiments of the present application, the source code file of the system to be upgraded is parsed to obtain a corresponding directed acyclic graph and, subsequently, the program feature information corresponding to each of nodes in the directed acyclic graph is supplemented. Next, the directed acyclic graph is split into a plurality of directed acyclic subgraphs to obtain a plurality of transformation recommendation paths. Further, based on the plurality of transformation recommendation paths, a final upgrade decision plan is generated. As such, problems of a legacy system are effectively identified, and solutions that align the program with optimal design principles such as single responsibility principle, functional isolation, clear hierarchy, high cohesion and low coupling, are also provided, thereby significantly reducing manual analysis and design costs, improving efficiency of modernization transformation research and development of the legacy system, avoiding transformation errors, and reducing transformation risks.

In some embodiments, after determining the upgrade decision plan for the system to be upgraded based on the plurality of directed acyclic subgraphs, the upgrade decision plan for the system to be upgraded is displayed.

Specifically, the upgrade decision plan for the system to be upgraded is displayed via a web interface. In addition, module relationships, program structures and program feature information of various functional metrics in the system to be upgraded may also be displayed, enabling users to intuitively understand the modernization transformation solutions and decision recommendations for the legacy system.

In some embodiments, the system to be upgraded is upgraded using the upgrade decision plan to obtain a target system. Specifically, for transformation scenarios that do not require introducing or replacing components, the upgrade decision plan is directly applied to upgrade the system to be upgraded to obtain and output the target system, thereby increasing the efficiency of modernization transformation research and development of the legacy system.

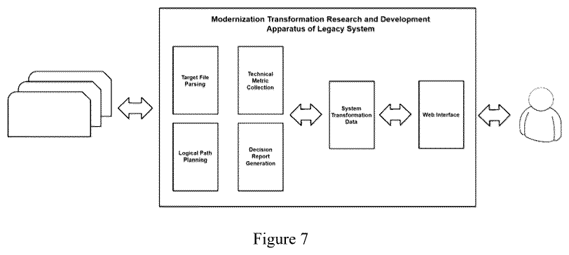

To better explain embodiments of the present application, a system upgrade method according to an embodiment of the present application is described below in conjunction with specific implementation scenarios. The method process may be executed by the modernization transformation research and development apparatus of legacy system 102 shown in FIG. 1. As illustrated in FIG. 7:

A source code file of a system to be upgraded is input into the modernization transformation research and development apparatus of legacy system. The modernization transformation research and development apparatus of legacy system sequentially performs target file parsing, technical metric collection, logical path planning and decision report generation on the source code file, to obtain system transformation data. The system transformation data is then displayed to users via a web interface.

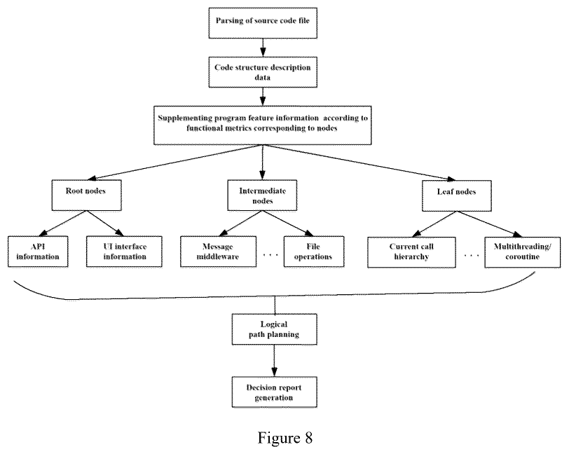

Specifically, the detailed processes of the target file parsing and technical metric collection are illustrated in FIG. 8. The specific process of the target file parsing comprises: parsing the source code file to obtain a corresponding preliminary directed acyclic graph for representing code structure description data of the source code file, wherein the code structure description data comprise: file name, function list, call code list, access code list, database access, file operations and parameterized configuration file list.

The specific process of the technical metric collection comprises: supplementing program feature information corresponding to each of nodes according to functional metrics corresponding to each of the nodes in the preliminary directed acyclic graph to obtain a target directed acyclic graph. For root nodes in the preliminary directed acyclic graph, API information and UI interface information are supplemented as node attributes. For intermediate nodes in the preliminary directed acyclic graph, information such as message middleware, network communication and file operations is supplemented as node attributes. For leaf nodes in the preliminary directed acyclic graph, usage information of current call hierarchy, synchronous/asynchronous, and multithreading/coroutine is supplemented as node attributes, thereby obtaining the target directed acyclic graph.

In embodiments of the present application, the source code file of the system to be upgraded is parsed to obtain a corresponding directed acyclic graph and, subsequently, the program feature information corresponding to each of nodes in the directed acyclic graph is supplemented. Next, the directed acyclic graph is split into a plurality of directed acyclic subgraphs to obtain a plurality of transformation recommendation paths. Further, based on the plurality of transformation recommendation paths, a final upgrade decision plan is generated. As such, problems of a legacy system are effectively identified, and solutions that align the program with optimal design principles such as single responsibility principle, functional isolation, clear hierarchy, high cohesion and low coupling, are also provided, thereby significantly reducing manual analysis and design costs, improving efficiency of modernization transformation research and development of the legacy system, avoiding transformation errors, and reducing transformation risks.

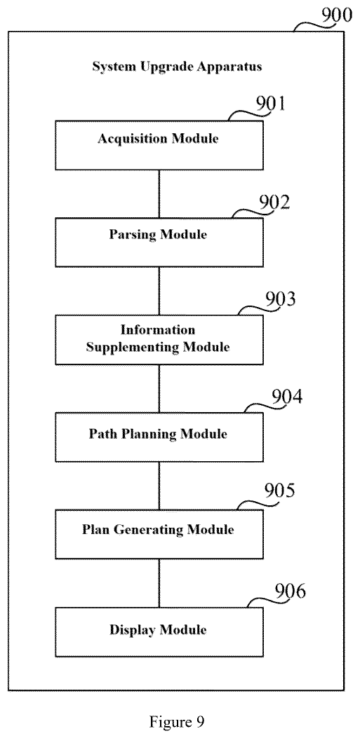

Based on the same technical concept, an embodiment of the present application provides a schematic structural diagram of a system upgrade apparatus. As shown in FIG. 9, the apparatus 900 comprises:
an acquisition module 901 for acquiring a source code file of a system to be upgraded; a parsing module 902 for parsing the source code file to obtain a corresponding preliminary directed acyclic graph, wherein the preliminary directed acyclic graph represents code structure description data of the source code file;
an information supplementing module 903 for supplementing program feature information corresponding to each of nodes according to functional metrics corresponding to each of the nodes in the preliminary directed acyclic graph to obtain a target directed acyclic graph;
a path planning module 904 for splitting the target directed acyclic graph into a plurality of directed acyclic subgraphs based on a plurality of root nodes in the target directed acyclic graph, wherein each of the directed acyclic subgraphs corresponds to an upgrade implementation path; and
a plan generating module 905 for determining an upgrade decision plan for the system to be upgraded based on the plurality of directed acyclic subgraphs.

Optionally, the parsing module 902 is specifically used for:
parsing the source code file to obtain a corresponding original graph structure; and
converting a directed cycle substructure into a directed acyclic substructure to obtain the preliminary directed acyclic graph, on the condition that the directed cycle substructure exists in the original graph structure.

Optionally, the parsing module 902 is specifically used for:
parsing the source code file based on syntax rules corresponding to a programming language of the source code file to obtain the corresponding original graph structure.

Optionally, the parsing module 902 is specifically used for:
adding a plurality of virtual nodes to the original graph structure, and transferring a portion of functions of at least one node in the directed cycle substructure to the plurality of virtual nodes, so as to convert the directed cycle substructure into a preliminary directed acyclic substructure; and
merging the plurality of virtual nodes with a nearest upstream node in the preliminary directed acyclic substructure to obtain the preliminary directed acyclic graph.

Optionally, the information supplementing module 903 is further used for:
obtaining the program feature information of the functional metrics corresponding to each of the nodes from the source code file through word segmentation technology, before supplementing the program feature information corresponding to each of the nodes according to the functional metrics corresponding to each of the nodes in the preliminary directed acyclic graph to obtain the target directed acyclic graph.

Optionally, the apparatus further comprises a display module 906 specifically used for:
displaying the upgrade decision plan for the system to be upgraded after determining the upgrade decision plan for the system to be upgraded based on the plurality of directed acyclic subgraphs.

Optionally, the path planning module 904 is further used for:
upgrading the system to be upgraded using the upgrade decision plan to obtain a target system after determining the upgrade decision plan for the system to be upgraded based on the plurality of directed acyclic subgraphs.

In embodiments of the present application, the source code file of the system to be upgraded is parsed to obtain a corresponding directed acyclic graph and, subsequently, the program feature information corresponding to each of nodes in the directed acyclic graph is supplemented. Next, the directed acyclic graph is split into a plurality of directed acyclic subgraphs to obtain a plurality of transformation recommendation paths. Further, based on the plurality of transformation recommendation paths, a final upgrade decision plan is generated. As such, problems of a legacy system are effectively identified, and solutions that align the program with optimal design principles such as single responsibility principle, functional isolation, clear hierarchy, high cohesion and low coupling, are also provided, thereby significantly reducing manual analysis and design costs, improving efficiency of modernization transformation research and development of the legacy system, avoiding transformation errors, and reducing transformation risks.

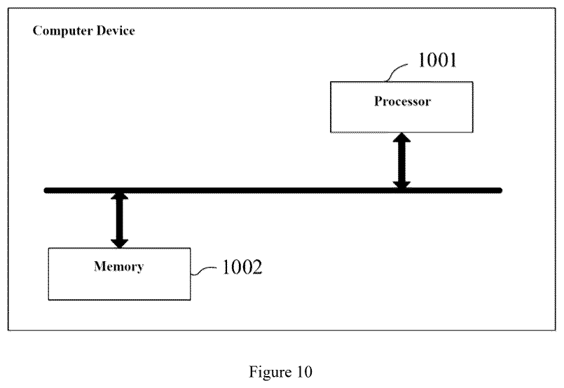

Based on the same technical concept, an embodiment of the present application provides a computer device. The computer device may be the modernization transformation research and development apparatus of legacy system shown in FIG. 1. As illustrated in FIG. 10, the computer device comprises at least one processor 1001 and a memory 1002 connected to the at least one processor 1001. The embodiments of the present application impose no limitation on the specific connection medium between the processor 1001 and the memory 1002. FIG. 10 exemplifies a connection between the processor 1001 and the memory 1002 via a bus, wherein the bus may be an address bus, a data bus, a control buses, etc.

In the embodiments of the present application, the memory 1002 stores instructions executable by the at least one processor 1001. By executing the instructions stored in the memory 1002, the at least one processor 1001 may perform the steps of the system upgrade method described above.

The processor 1001 serves as a control center of the computer device that may connect various components of the computer device through different interfaces and circuits, wherein the processor 1001 executes instructions stored in the memory 1002 and calls data stored in the memory 1002 to implement system upgrades. Optionally, the processor 1001 may comprise one or more processing units, and may integrate an application processor and a modem processor, wherein the application processor mainly handles operating systems, user interfaces and applications while the modem processor mainly processes wireless communications. As is understandable, the modem processor may alternatively be implemented separately from the processor 1001. In some embodiments, the processor 1001 and the memory 1002 may be implemented on the same chip, while in other embodiments, the processor 1001 and the memory 1002 may reside on separate chips.

The processor 1001 may be a general-purpose processor, such as a Central Processing Unit (CPU), Digital Signal Processor, Application-Specific Integrated Circuit (ASIC), Field-Programmable Gate Array or other programmable logic device, discrete gate or transistor logic device, discrete hardware component, capable of implementing or executing the methods, steps, and logic block diagrams disclosed in the embodiments of the present application. The general-purpose processor may be a microprocessor or any conventional processor. The method steps disclosed in the embodiments of the present application may be directly embodied as completed by hardware processors or through a combination of hardware and software modules in the processors.

The memory 1002, as a non-volatile computer-readable storage medium, may store non-volatile software programs, non-volatile computer-executable programs and modules. The memory 1002 may comprise at least one type of storage media, such as flash memory, hard disks, multimedia cards, card-type memory, Random Access Memory (RAM), Static Random Access Memory (SRAM), Programmable Read-Only Memory (PROM), Read-Only Memory (ROM), Electrically Erasable Programmable Read-Only Memory (EEPROM), magnetic memory, magnetic disks, optical disks, etc. The memory 1002 may be any other medium capable of carrying or storing desired program code in the form of instructions or data structures and accessible by computer devices, though not limited to these examples. In the embodiments of the present application, the memory 1002 may also be implemented as circuits, or any other devices capable of storage functions, for storing program instructions and/or data.

Based on the same inventive concept, an embodiment of the present application provides a computer-readable storage medium storing a computer program executable by a computer device. When executed on the computer device, the computer program enables the computer device to perform steps of the system upgrade method as described above.

Based on the same inventive concept, an embodiment of the present application provides a computer program product comprising a computer program stored on a computer-readable storage medium. The computer program comprises program instructions, wherein the program instructions, when executed by the computer device, enable the computer device to implement steps of the system upgrade method as described above.

As those skilled in the art should appreciate, the embodiments of the present application may be provided as methods or computer program products. Accordingly, the present application may take the form of an entirely hardware embodiment, an entirely software embodiment, or an embodiment combining software and hardware aspects. Furthermore, the present application may take the form of a computer program product implemented on one or more computer-usable storage media (including but not limited to disk storage, CD-ROM, optical storage, etc.) containing computer-usable program code.

The present application is described with reference to the flowcharts and/or block diagrams of the methods, apparatuses (systems), and computer program products according to the embodiments of the present application. As should be understood, each process and/or block in the flowcharts and/or block diagrams, and combinations of processes and/or blocks in the flowcharts and/or block diagrams, may be implemented by computer program instructions. The computer program instructions may be provided to a processor of a general-purpose computer, special-purpose computer, embedded processor, or other programmable data processing device to produce a machine, enabling the instructions executed by the processor of the computer device or other programmable data processing device to create means for implementing the functions specified in one or more processes of the flowchart and/or one or more blocks of the block diagram.

The computer program instructions may also be stored in a computer-readable memory capable of directing a computer device or other programmable data processing device to function in a particular manner, such that the instructions stored in the computer-readable memory generate an article of manufacture including instruction means, wherein the instruction means implement the functions specified in one or more processes of the flowchart and/or one or more blocks of the block diagram.

The computer program instructions may also be loaded onto a computer device or other programmable data processing device, causing a series of operational steps to be performed on the computer device or other programmable device to produce computer device-implemented processing, such that the instructions executed on the computer device or other programmable device provide steps for implementing the functions specified in one or more processes of the flowchart and/or one or more blocks of the block diagram.

Although the embodiments of the present application are described, those skilled in the art may make additional alterations and modifications to the embodiments once they learn the basic creative concept. Accordingly, the appended claims are intended to be interpreted as including the embodiments and all alterations and modifications falling within the scope of the present application.

Evidently, those skilled in the art may make various modifications and variations to the present application without departing from the spirit and scope of the present application. Thus, when such modifications and variations of the present application fall within the scope of the claims of the present application and the scope of the equivalents, the present application is also intended to include the modifications and variations.

1. A system upgrade method, comprising:
acquiring a source code file of a system to be upgraded;
parsing the source code file to obtain a corresponding preliminary directed acyclic graph, wherein the preliminary directed acyclic graph represents code structure description data of the source code file;
supplementing program feature information corresponding to each of nodes according to functional metrics corresponding to each of the nodes in the preliminary directed acyclic graph to obtain a target directed acyclic graph;
splitting the target directed acyclic graph into a plurality of directed acyclic subgraphs based on a plurality of root nodes in the target directed acyclic graph, wherein each of the directed acyclic subgraphs corresponds to an upgrade implementation path; and
determining an upgrade decision plan for the system to be upgraded based on the plurality of directed acyclic subgraphs.

2. The method according to claim 1, wherein parsing the source code file to obtain the corresponding preliminary directed acyclic graph comprises:
parsing the source code file to obtain a corresponding original graph structure; and
converting a directed cycle substructure into a directed acyclic substructure to obtain the preliminary directed acyclic graph, on the condition that the directed cycle substructure exists in the original graph structure.

3. The method according to claim 2, wherein parsing the source code file to obtain the corresponding original graph structure comprises:
parsing the source code file based on syntax rules corresponding to a programming language of the source code file to obtain the corresponding original graph structure.

4. The method according to claim 2, wherein converting the directed cycle substructure into the directed acyclic substructure to obtain the preliminary directed acyclic graph comprises:
adding a plurality of virtual nodes to the original graph structure, and transferring a portion of functions of at least one node in the directed cycle substructure to the plurality of virtual nodes, so as to convert the directed cycle substructure into a preliminary directed acyclic substructure; and
merging the plurality of virtual nodes with a nearest upstream node in the preliminary directed acyclic substructure to obtain the preliminary directed acyclic graph.

5. The method according to claim 1, wherein before supplementing the program feature information corresponding to each of the nodes according to the functional metrics corresponding to each of the nodes in the preliminary directed acyclic graph to obtain the target directed acyclic graph, the method further comprises:
obtaining the program feature information of the functional metrics corresponding to each of the nodes from the source code file through word segmentation technology.

6. The method according to claim 1, wherein after determining the upgrade decision plan for the system to be upgraded based on the plurality of directed acyclic subgraphs, the method further comprises:
displaying the upgrade decision plan for the system to be upgraded.

7. The method according to claim 1, wherein after determining the upgrade decision plan for the system to be upgraded based on the plurality of directed acyclic subgraphs, the method further comprises:
upgrading the system to be upgraded using the upgrade decision plan to obtain a target system.

8. (canceled)

9. A computer device, comprising:
one or more processors; and
a memory containing a computer program that, when being executed, causes the one or more processors to perform:
acquiring a source code file of a system to be upgraded;
parsing the source code file to obtain a corresponding preliminary directed acyclic graph, wherein the preliminary directed acyclic graph represents code structure description data of the source code file;
supplementing program feature information corresponding to each of nodes according to functional metrics corresponding to each of the nodes in the preliminary directed acyclic graph to obtain a target directed acyclic graph;
splitting the target directed acyclic graph into a plurality of directed acyclic subgraphs based on a plurality of root nodes in the target directed acyclic graph, wherein each of the directed acyclic subgraphs corresponds to an upgrade implementation path; and
determining an upgrade decision plan for the system to be upgraded based on the plurality of directed acyclic subgraphs.

10. A non-transitory computer-readable storage medium containing a computer program that, when being executed, causes at least one processor to perform:
acquiring a source code file of a system to be upgraded;
parsing the source code file to obtain a corresponding preliminary directed acyclic graph, wherein the preliminary directed acyclic graph represents code structure description data of the source code file;
supplementing program feature information corresponding to each of nodes according to functional metrics corresponding to each of the nodes in the preliminary directed acyclic graph to obtain a target directed acyclic graph;
splitting the target directed acyclic graph into a plurality of directed acyclic subgraphs based on a plurality of root nodes in the target directed acyclic graph, wherein each of the directed acyclic subgraphs corresponds to an upgrade implementation path; and
determining an upgrade decision plan for the system to be upgraded based on the plurality of directed acyclic subgraphs.

11. (canceled)
